(19) United States
(12) Patent Application Publication
(10) Pub. No.: US 2003/0158922 A1
(43) Pub. Date: Aug. 21, 2003

(54) Method for operating wireless LAN card in wireless LAN system

(75) Inventor: Yong Jin Park, Suwon (KR)

Correspondence Address: LOWE HAUPTMAN GOPSTEIN GILMAN & BERNER, LLP, Suite 310, 1700 Diagonal Road, Alexandria, VA, 22314, US

(73) Assignee: Samsung Electro-Mechanics Co., Ltd.

(21) Appl. No.: 10/147,039

(22) Filed: May 17, 2002

(30) Foreign Application Priority Data
Feb. 19, 2002 (KR) 2002-8687

(51) Int. Cl. G06F 15/177

(52) U.S. Cl. 709/222

(57) ABSTRACT

A method for operating a wireless LAN card in a wireless LAN system. The present invention relates to the wireless LAN card operation method which is capable of receiving a beacon signal of an access point and setting a frequency band set with respect to the access point as a communication channel, in an infrastructure mode, while in an Ad-hoc mode, setting a frequency band used in common in all regions as the communication channel, thereby meeting requirements of communication standards of all countries. The wireless LAN operation method comprises the steps of registering as channels allowed in the wireless LAN card all frequency bands recommended as wireless communication channels in a wireless LAN, performing in an Ad-hoc mode an access to a target terminal via a channel 10 or a channel 11 used in common in all countries, and, in an infrastructure mode, scanning the respective frequency bands of the allowed channels to receive beacon signals, and securing a channel to communicate with an access point over the secured channel.

### BACKGROUND OF THE INVENTION

1. Field of the Invention

The present invention relates to an wireless local area network (LAN), and more particularly to a method for operating a wireless LAN card in a wireless LAN system, in which the wireless LAN card can be set suitably for any one of channels, which are differently established in respective countries according to communication standards defined in the respective countries, thereby enabling a global use thereof.

2. Description of the Related Art

Generally, a wireless LAN is a LAN that enables a wireless data transmission/reception between computers or between a computer and other communication equipment using radio frequency (RF) or infrared technologies. This wireless LAN has been developed due to development of Internet services and wireless communication technologies. The wireless LAN is advantageous in that it enables a connection to a network in a building and that it can be easily installed in a large office, commodity distribution center, exhibition hall or the like in which a wired network cannot easily installed. Further, maintenance of the wireless LAN is simple. For these reasons, recently, the wireless LAN has been rapidly popularized.

FIG. 1 is a view schematically showing the construction of the wireless LAN. In this drawing, the reference numeral 11 denotes a plurality of user terminals in which wireless LAN cards 10 are respectively installed. Also, the reference numeral 12 denotes access points (APs), the reference numeral 13 a hub, and the reference numeral 14 the Internet. The access point 12 is an interface between each user terminal 11 and the hub 13. Namely, the access point 12 acts as a bridge for wireless LAN communications between the corresponding user terminal and the hub 13 by transmitting an Internet access request from the user terminal.

The access point 12 is connected to the user terminals 11. If the number of the user terminals 11 exceeds a reference value (for example, 25) meaning the capacity of the access point 12, another access point is additionally installed to share load of the access point 12.

The user terminal 11 may be a communication port such as a PCMCIA port or USB port, or a typical computer such as a notebook computer having PCI slots, desktop computer or personal digital assistant (PDA). The user terminal 11 has the wireless LAN card 10, which will be described below.

FIG. 2 is block diagram showing a basic construction of the wireless LAN card 10 installed in the user terminal 11 of FIG. 1.

As shown in FIG. 2, the wireless LAN card 10 includes a radio transmitter/receiver 21, baseband processor 22 and medium access control (MAC) processor 23. The radio transmitter/receiver 21 functions to perform a reception process with respect to radio signals received from the access point 12, and perform a transmission process where data to be transmitted to the access point 12 is converted into radio signals. The baseband processor 22 functions to demodulate data received through the radio transmitter/receiver 21 and modulate data to be transmitted to the access point 12 through the radio transmitter/receiver 21. The MAC processor 23 functions to perform a data link process such as channel securing according to a MAC protocol (for example, IEEE 802.11) between the access point 12 and the user terminal 11.

In the wireless LAN system as shown FIG. 1, in the case where a new user terminal is installed, a wireless LAN card in the installed new user terminal scans all channels to receive beacon signals from the access point 12. Then, the wireless LAN card reads out information contained in frames of the received beacon signals and sets a channel set with respect to the access points 12 to a data communication channel.

In general, access points 12 with respect to which different channels are respectively established transmit respective beacon signals to a user terminal. In response to the beacon signals, the user terminal sends probe requests to the respective access points 12 having transmitted the beacon signals. If the respective access points 12 transmit probe responses to the user terminal in response to the probe requests, the user terminal receives the probe responses and determines which access point is the first to transmit a probe response so as to transmit an access request to the determined access point.

There are Ad-hoc (IBSS, or Independent Basic Service Set) and infrastructure (BSS, or Basic Service Set) modes in an operation mode of the wireless LAN card 10. The Ad-hoc (IBSS) mode is a mode where the access point 12 is not needed and communications between wireless clients is supported. The infrastructure (BSS) mode is a mode where the access point 12 is used and allows a network to be established so as to enable a wired network access.

In the infrastructure mode, the user terminal 11 determines which channel is set with respect to the access point 12 through a communication with the access point 12 and uses the determined channel. In the Ad-hoc mode, the user terminal 11 selects a channel among channels respectively used in different countries and uses the selected channel in communications.

The following table 1 lists center frequencies in a wireless LAN card's operating frequency band, which center frequencies are allowed for major countries according to IEEE 802.11 specification.

TABLE 1

| | center | U.S.A./ | | | | |
|---|---|---|---|---|---|---|
| channel | frequency | Canada | Europe | France | Spain | Korea |
| 1 | 2412 MHz | ◯ | ◯ | | | ◯ |
| 2 | 2417 MHz | ◯ | ◯ | | | ◯ |
| 3 | 2422 MHz | ◯ | ◯ | | | ◯ |
| 4 | 2427 MHz | ◯ | ◯ | | | ◯ |
| 5 | 2432 MHz | ◯ | ◯ | | | ◯ |
| 6 | 2437 MHz | ◯ | ◯ | | | ◯ |
| 7 | 2442 MHz | ◯ | ◯ | | | ◯ |
| 8 | 2447 MHz | ◯ | ◯ | | | ◯ |
| 9 | 2452 MHz | ◯ | ◯ | | | ◯ |
| 10 | 2457 MHz | ⊚ | ⊚ | ⊚ | ⊚ | ⊚ |
| 11 | 2462 MHz | ⊚ | ⊚ | ⊚ | ⊚ | ⊚ |
| 12 | 2467 MHz | | ◯ | ◯ | | ◯ |
| 13 | 2472 MHz | | ◯ | ◯ | | ◯ |
| 14 | 2484 MHz | | | | | |

In the above table 1, Canada or U.S.A. uses center frequencies in a frequency band of approximately 2412 MHz to 2462 MHz. Europe and Korea use a frequency band of 2412 MHz to 2462 MHz, most of a recommended frequency band. France uses a frequency band of only 2457 MHz to 2472 MHz, and Spain only 2457 Mhz to 2462 Mhz.

Firmware for driving the wireless LAN card 10 constructed in a hardware manner as stated previously includes an initial firmware, primary firmware, secondary firmware and a PDA file. The initial firmware is provided to download a driving firmware in an empty flash memory at the beginning of installation. The primary firmware is provided to initialize the wireless LAN card 10 and update firmware. The secondary firmware is provided to implement a communication protocol (IEEE 802.11) for the wireless LAN. The PDA file stores characteristics of the wireless LAN card. In a PDA list, an “allowed channel” record, related to settings of an available frequency band, has a 16-bit length as shown in FIG. 3. Each bit in the record represents an allowed channel, or a frequency allowed to be used by the wireless LAN card 10, of recommended channels as shown in the above table 1.

For example, in the case where the wireless LAN card 10 is used in Canada or U.S.A., channels 1 to 11 can be used, as shown in the table 1. In this case, a record value is expressed as “0000 0111 1111 1111”, that is, 0×1FFF.

As described above, conventionally, frequency bands used in respective countries are different, and the PDA file varies with a usable frequency band. Also, the firmware downloaded in the wireless LAN card has to be changed according to the variation of the PDA file. In this regard, conventional wireless LAN cards have been manufactured and managed in a different way, and sold according to the respective counties.

Therefore, manufacturers and sellers of the wireless LAN cards have the trouble of manufacturing, managing and selling them suitably to the respective countries. Further, users have to use different wireless LAN cards corresponding to the respective countries.

### SUMMARY OF THE INVENTION

Therefore, the present invention has been made in view of the above problems, and it is an object of the present invention to provide a method for operating a wireless LAN card in a wireless LAN system, which is capable of receiving a beacon signal of an access point and setting a frequency band set with respect to the access point as a communication channel, in an infrastructure mode, while in an Ad-hoc mode, setting a frequency band used in common in all regions as the communication channel, thereby meeting requirements of communication standards of all countries.

In accordance with the present invention, the above and other objects can be accomplished by the provision of a method for operating a wireless LAN card in a wireless LAN system comprising the steps of a) registering as channels allowed in the wireless LAN card all frequency bands recommended as wireless communication channels in a wireless LAN; b) determining whether an operation mode of the wireless LAN card is an Ad-hoc mode; c), if the operation mode is the Ad-hoc mode, performing an access to a target terminal via a channel 10 or a channel 11 used in common in all countries; d), if the operation mode is not the Ad-hoc mode, scanning the respective frequency bands of the allowed channels and receiving beacon signals respectively associated with the allowed channels; and e) analyzing the received beacon signals and performing an access to desired access point on the basis of the analysis result; whereby the wireless LAN card is initialized.

Preferably, the step a) is implemented in such a way that a record value in a PDA file is set to a value representing all allowed channels.

Preferably, the wireless LAN card operation method further comprises the steps of f) analyzing the received beacon signals to determine whether there is present an access point having a hidden service set identifier (SSID); g), if there is present the access point having the hidden SSID, transmitting a probe request containing an SSID set in the wireless LAN card over only a channel to the access point, and, if receiving a probe response from the access point, accessing the access point having transmitted the probe response; and h), if there is no access point having the hidden SSID, comparing SSIDs of the received beacon signals with the SSID set in the wireless LAN card to detect an access point having the same SSID as the SSID set in the wireless LAN card, and accessing the detected access point.

More preferably, the step f) includes the step of f-1) checking each of the SSIDs of the received beacon signals to determine whether the corresponding SSID consists of null bits, and, if the SSID consists of the null bits, determining that the SSID is the hidden SSID.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a general wireless local area network (LAN);

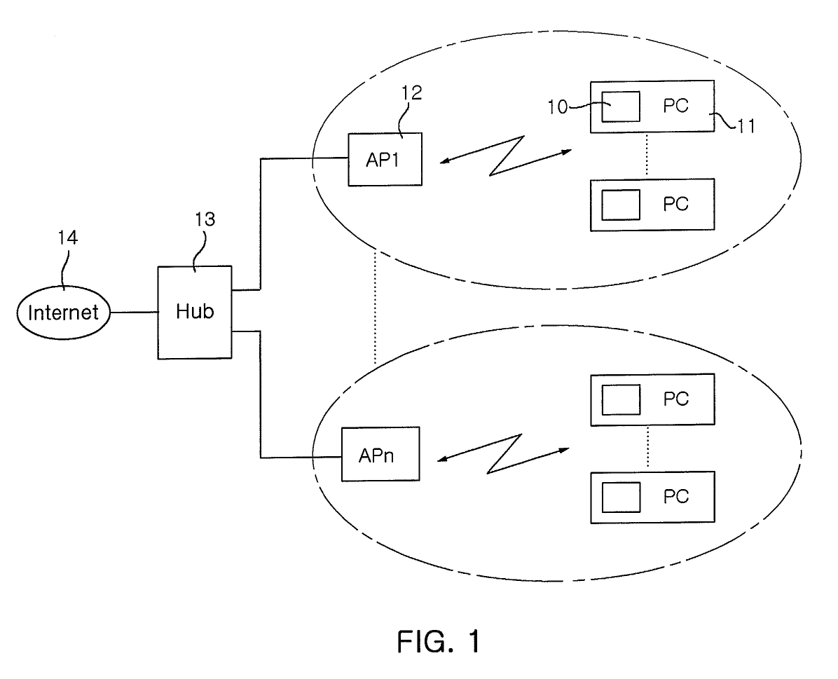

FIG. 2 is block diagram showing the construction of a wireless LAN card;

FIG. 3 is a table showing the structure of a record associated with a channel setting; and

FIG. 4 is a flow chart illustrating a procedure of operating a wireless LAN card.

### DESCRIPTION OF THE PREFERRED EMBODIMENTS

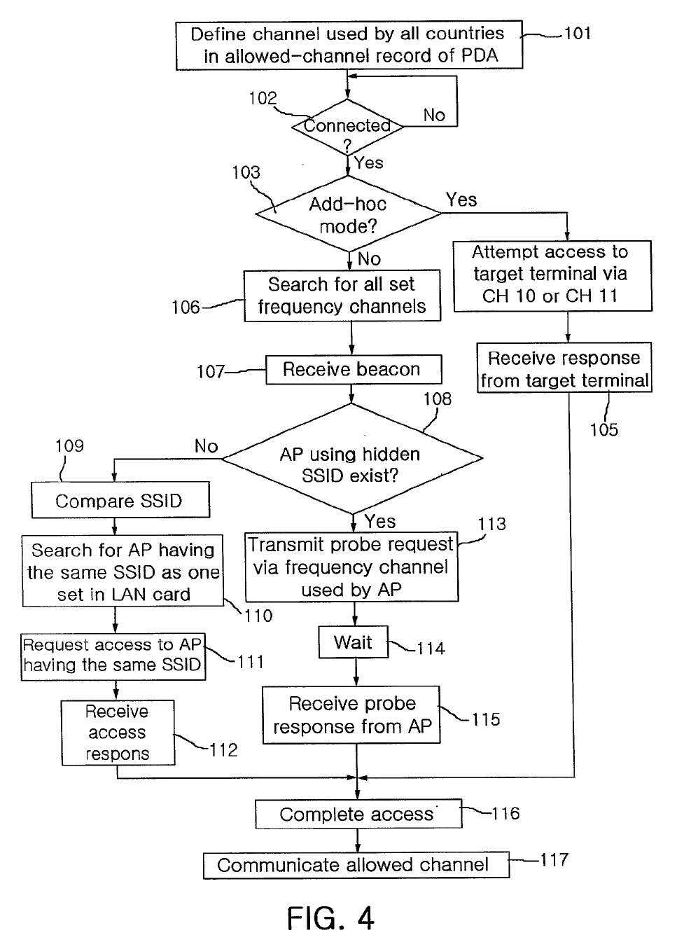

FIG. 4 is a flow chart illustrating a wireless LAN card operating method according to an embodiment of the present invention. With reference to this drawing, the present invention will be described in detailed.

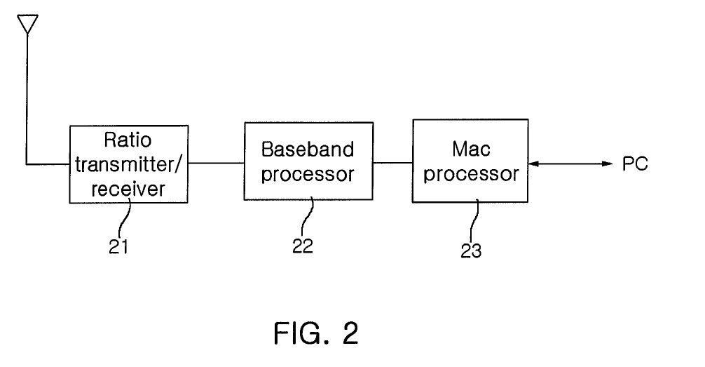

A wireless LAN card, which enables a user terminal to perform a wireless data communication, has the wireless transmission/reception unit 21, baseband processor 22 and MAC processor 23 as shown in FIG. 2.

In the MAC processor, firmware for operating the wireless LAN card is installed. This firmware includes, as described above, the initial firmware, primary firmware for initializing the wireless LAN card and updating firmware, secondary firmware for implementing a communication protocol (IEEE 802.11) for a wireless LAN, and PDA file for storing characteristics of the wireless LAN card.

First, values corresponding to all channels to be allowed in the wireless data communication are set in an allowed-channel record of the PDA file, which is a base of operation of the secondary firmware, according to the preferred embodiment of the present invention (S101).

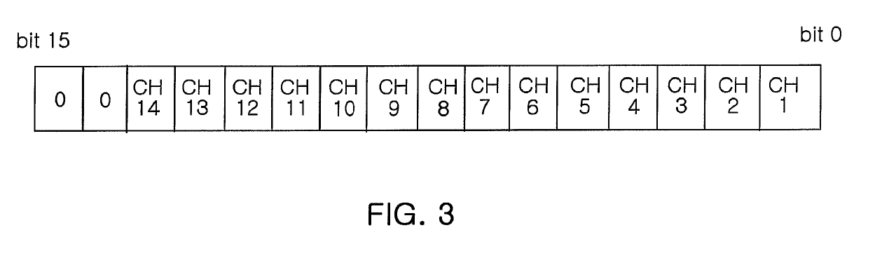

Namely, bits corresponding to the channels 1 to 13, or CH1 to CH13, are respectively set to ls as shown in FIG. 3, so that a value of the allowed-channel record of the PDA file is registered to be “0001 1111 1111 1111”.

If the wireless LAN card in which the PDA file is downloaded is ready to access the wireless LAN, that is, the wireless LAN card has been initialized, it is determined which operation mode of the wireless LAN card is an Ad-hoc mode or infrastructure mode (S102 and S103).

If it is determined at step 103 that the operation mode is the Ad-hoc mode where the wireless LAN card is allowed to perform one-to-one communication with other user terminals without an access point, the wireless LAN card searches stored information and attempts a one-to-one access to a target user terminal via a channel 10 or channel 11 of a center frequency 2457 MHz or 2462 MHz (S104 and S105). The one-to-one access procedure is performed in the same manner as a general one-to-one access.

On the other hand, if it is determined at step 103 that the operation mode is not the Ad-hoc mode but the infrastructure mode, the wireless LAN card checks the allowed-channel record of the PDA file and sequentially scans and searches frequency bands of the allowed channels (S106). Then, the wireless LAN card receives and analyzes beacon signals transmitted via the respective channels during the scanning (S107). Each of the beacon signals has a frame containing a service set identifier (SSID).

The wireless LAN card checks the received SSIDs in the beacon signals and determines whether there is present an access point having a unopened SSID (S108).

The SSID is information enabling identification of network established between a number of access points and a number of clients. Each access point has a unique SSID and transmits a beacon signal containing its unique SSID to a client so as to enable the client to identify it.

For security of a network, an SSID record value of a beacon signal is set to “0” to keep an SSID hidden such that only a user who knows the SSID can access the network. The SSID set to be “0” is called a hidden SSID.

If it is determined at step 108 that there is present an access point having the hidden SSID, the wireless LAN card transmits to the access point a probe request, in the format of packets, containing an SSID which is set therein or entered from a user of the user terminal (S113).

Then, the wireless LAN card waits for a probe response to the probe request. If the probe response is transmitted from the access point having the hidden SSID, the wireless LAN receives the probe response (S115).

Now the wireless LAN card's access to the access point is completed, in the case where security is set.

On the other hand, if it is determined at step 108 that there is no access point having the hidden SSID, the wireless LAN card compares its SSID set therein with each of the SSIDs contained in the received beacon signals to detect an access point having the same SSID as its SSID. Then, the wireless LAN card performs an access process with respect to the access point having the same SSID as its SSID (S109-S112).

When having gained access to an access point in the case of the one-to-one access, infrastructure mode or security access, the wireless LAN card performs a data communication with the access point through a secured channel (S116 and S117).

As apparent from the above description, the present invention provides a method for operating a wireless LAN card in a wireless LAN system, which is capable of allowing the wireless LAN card to gain a one-to-one access to a target terminal in an Ad-hoc mode over a frequency channel employed in common in most countries such as Europe, U.S.A. and so forth. Further, the wireless LAN card operation method according to the present invention is capable of allowing the wireless LAN card to perform a data communication in an infrastructure mode over a frequency channel on the basis of a value set in a corresponding access point. So, there is an effect that a user can use the wireless LAN card in any country.

Further, the wireless LAN card operation method allows the same PDA file to be listed in the wireless LAN card regardless of the kind of a communication channel standard associated with the wireless LAN card, so that the user can use the wireless LAN card in any country, thereby it is easy to list and manage the PDA file.

Furthermore, in the present invention, because the same PDA is used in all countries, it is possible to use the same wireless LAN card, resulting in a convenience in manufacture, management and use.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for operating a wireless LAN card in a wireless LAN system comprising the steps of:
a) registering as channels allowed in the wireless LAN card all frequency bands recommended as wireless communication channels in a wireless LAN;
b) determining whether an operation mode of the wireless LAN card is an Ad-hoc mode;
c), if the operation mode is the Ad-hoc mode, performing an access to a target terminal via a channel 10 or a channel 11 used in common in all countries;
d), if the operation mode is not the Ad-hoc mode, scanning the respective frequency bands of the allowed channels and receiving beacon signals respectively associated with the allowed channels; and
e) analyzing the received beacon signals and performing an access to desired access point on the basis of the analyzed result;
whereby the wireless LAN card is initialized.

2. The method as set forth in claim 1, wherein the step a) is implemented in such a way that a record value in a PDA file is set to a value representing the entire allowed channels.

3. The method as set forth in claim 1, further comprising the steps of:
f) analyzing the received beacon signals to determine whether there is present an access point having a hidden service set identifier (SSID);
g), if there is present the access point having the hidden SSID, transmitting a probe request containing an SSID set in the wireless LAN card over only a channel to the access point, and, if receiving a probe response from the access point, accessing the access point having transmitted the probe response; and
h), if there is no access point having the hidden SSID, comparing SSIDs of the received beacon signals with the SSID set in the wireless LAN card to detect an access point having the same SSID as the SSID set in the wireless LAN card, and accessing the detected access point.

4. The method as set forth in claim 3, wherein the step f) including the step of:
f-1) checking each of the SSIDs of the received beacon signals to determine whether the corresponding SSID consists of null bits, and, if the SSID consists of the null bits, determining that the SSID is the hidden SSID.
